(19) United States
(12) Patent Application Publication
(10) Pub. No.: US 2012/0034026 A1
(43) Pub. Date: Feb. 9, 2012

(54) Single-sided fitting

(75) Inventors: Rowan Bridgeley, Bristol (GB); John Hobday, Bristol (GB)

(73) Assignee: AIRBUS OPERATIONS LIMITED, Bristol (GB)

(21) Appl. No.: 13/137,142

(22) Filed: Jul. 22, 2011

(30) Foreign Application Priority Data
Aug. 3, 2010 (GB) 1012987.2

(51) Int. Cl. F16B 17/00

(52) U.S. Cl. 403/290

(57) ABSTRACT

A single-sided fitting comprising a shaft with two or more axially extending legs. Each leg has a catch which extends radially outwardly from the leg. A clamping plate has two or more holes each receiving a respective one of the legs. A projection is carried by the clamping plate and extends axially between the legs towards the catches. The clamping plate and projection are axially movable along the shaft to a locking position where the projection is positioned between the catches thus preventing the catches from moving radially inwardly. Means are provided for preventing the clamping plate and projection from withdrawing back along the shaft away from the catches after they have been moved to the locking position. For instance an internally threaded nut may be carried by the shaft, the clamping plate being positioned between the nut and the catches, wherein the nut can be spun along the shaft to engage the clamping plate in its locking position.

### FIELD OF THE INVENTION

The present invention relates to a single-sided fitting.

### BACKGROUND OF THE INVENTION

A bracket or other object can be fixed to a panel by a nut and a bolt, but this requires access to both the front and rear faces of the panel.

So-called “blind rivets” are known, which do not require access to the rear side of the panel. However, such blind rivets cannot be removed easily.

### SUMMARY OF THE INVENTION

A first aspect of the invention provides a single-sided fitting comprising a shaft with two or more axially extending legs, each leg having a catch which extends radially outwardly from the leg; a clamping plate with two or more holes each receiving a respective one of the legs; a projection which is carried by the clamping plate and extends axially between the legs towards the catches, the clamping plate and projection being axially movable along the shaft to a locking position where the projection is positioned between the catches thus preventing the catches from moving radially inwardly; and means for preventing the clamping plate and projection from withdrawing back along the shaft away from the catches after they have been moved to the locking position.

A further aspect of the invention provides an assembly of parts comprising a structure with a hole passing from a front face of the structure to a rear face of the structure; and a single-sided fitting according to the first aspect of the invention arranged with the shaft passing through the hole, the clamping plate in its locking position applying a compressive force to the front face of the structure, the projection positioned between the catches thus preventing the catches from moving radially inwardly, and the catches applying a compressive force to the rear face of the structure.

The structure may comprise a panel, a pair of panels which are fastened together by the fitting, or any other structure.

A further aspect of the invention provides a method of attaching a single-sided fitting to a structure, the single-sided fitting comprising a shaft with two or more axially extending legs, each leg having a catch which extends radially outwardly from the leg; a clamping plate with two or more holes each receiving a respective one of the legs, and a projection which is carried by the clamping plate and extends axially between the legs towards the catches, the method comprising:
passing the shaft and the catches through a hole from a front face of the structure to a rear face of the structure;
moving the catches radially outwardly so they cannot be withdrawn back through the hole;
moving the clamping plate and projection axially along the shaft to a locking position in which the clamping plate engages the front face of the structure and the projection is positioned between the catches, thus preventing the catches from moving radially inwardly;
applying a compressive force to the front face of the structure with the clamping plate;
applying a compressive force to the rear face of the structure with the catches; and
preventing the clamping plate and projection from withdrawing back along the shaft away from the catches after they have been moved to the locking position.

The single-sided fitting can be removed easily by reversing the procedure described above, that is by withdrawing the clamping plate and projection back along the shaft away from the catches; moving the catches radially inwardly; and withdrawing the shaft and the catches from the hole.

Compressing the structure between the clamping plate and the catches makes the fitting secure and unlikely to come loose due to vibration. This makes the single-sided fitting particularly well suited for use in a vehicle such as an aircraft which is prone to vibration.

The means for preventing the clamping plate and projection from moving back along the shaft may have a number of forms. For instance it may comprise an internally threaded nut which is carried by the shaft, the clamping plate being positioned between the nut and the catches, wherein the nut can be spun along the shaft to engage the clamping plate in its locking position. Alternatively the shaft may have a series of closely spaced resilient teeth which retract one by one as the clamping plate is moved along the shaft until it engages the structure, at which point the teeth prevent the clamping plate from withdrawing easily. Alternatively the shaft may have a series of closely spaced rigid teeth which are engaged by a resilient catch on the clamping plate, in the manner of a zip-tie. Alternatively, a coil spring or other resilient means may be used to urge the clamping plate towards its locking position in order to prevent it from withdrawing.

The single-sided fitting may be used as a fastener for fastening together a pair of panels, as a bracket for mounting a component to a panel or other structure, or for any other suitable purpose.

Typically the projection passes through the hole and beyond the rear face of the structure, although it may lie flush with the rear face.

The shaft may have two legs only, or it may have three or more legs.

The legs may be completely separate parts, but more preferably they are joined together at a head of the shaft remote from the catches. This provides a resilient force which causes the catches to spring radially outwardly after they have passed through the hole.

The catches may be at an intermediate position along the length of the legs, but more preferably they are at a distal end of the legs.

### BRIEF DESCRIPTION OF THE DRAWINGS

Embodiments of the invention will now be described with reference to the accompanying drawings, in which:

FIG. 1 is a plan view of a bracket;

FIG. 2 is a plan view of the bracket with the washer and nut removed;

FIG. 3 is a side view of the bracket with the washer and nut removed;

FIG. 4 is a rear view of the bracket with the washer and nut removed, viewed from the left of FIG. 3;

FIG. 5 is a section taken along a line A-A in FIG. 3;

FIG. 6 is a plan view of a washer;

FIG. 7 is a front view of the washer, viewed from the left of FIG. 6;

FIG. 8 is a plan view of a nut;

FIG. 9 is a rear view of the nut, viewed from the left of FIG. 8;

FIG. 10 is a plan view showing the bracket coupled to a panel with the washer in its locking position and the nut in its retracted position; and

FIG. 11 is a plan view showing the bracket fixed to the panel with both the nut and washer in their locking positions.

### DETAILED DESCRIPTION OF EMBODIMENT(S)

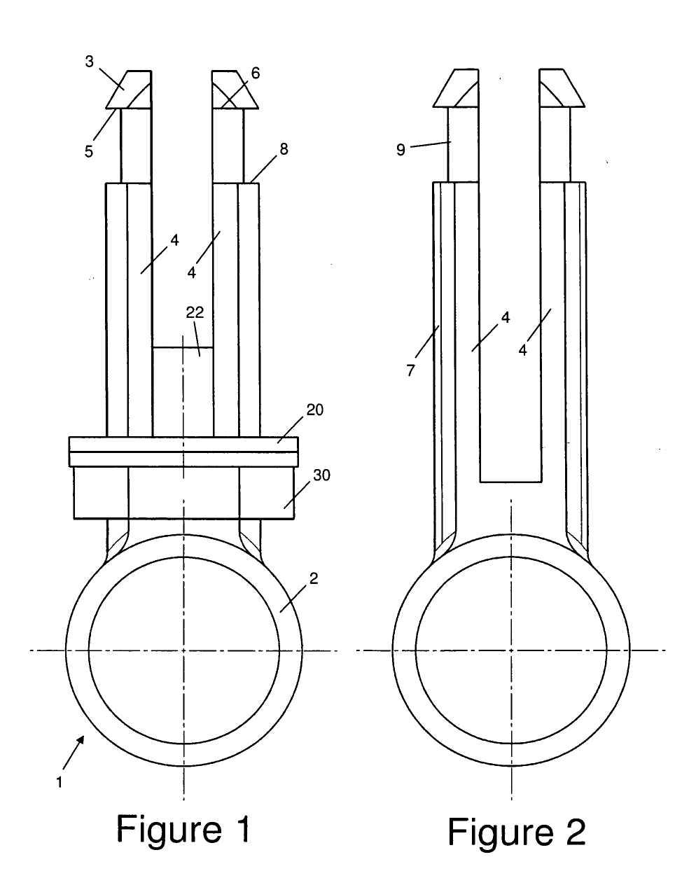

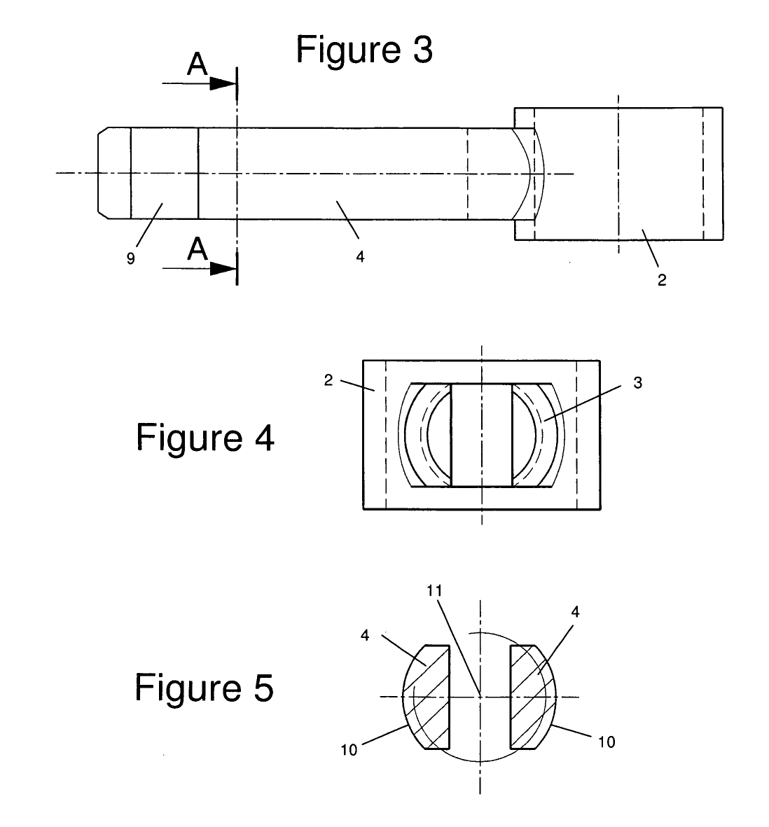

A single-sided bracket 1 shown in FIG. 1 comprises a head 2, and a shaft comprising two legs 4 which extend axially from the head 2 as shown most clearly in FIG. 2. Each leg has a catch 3 with a rear-directed face or lip 5 extending radially outwardly from a distal end 6 of the leg. The legs 4 are each formed with an external thread 7. The thread 7 extends from the head 2 to a point 8 which is set back from the catches by an unthreaded gap 9. The unthreaded gap 9 enables the catches to be relatively compact in a radial direction.

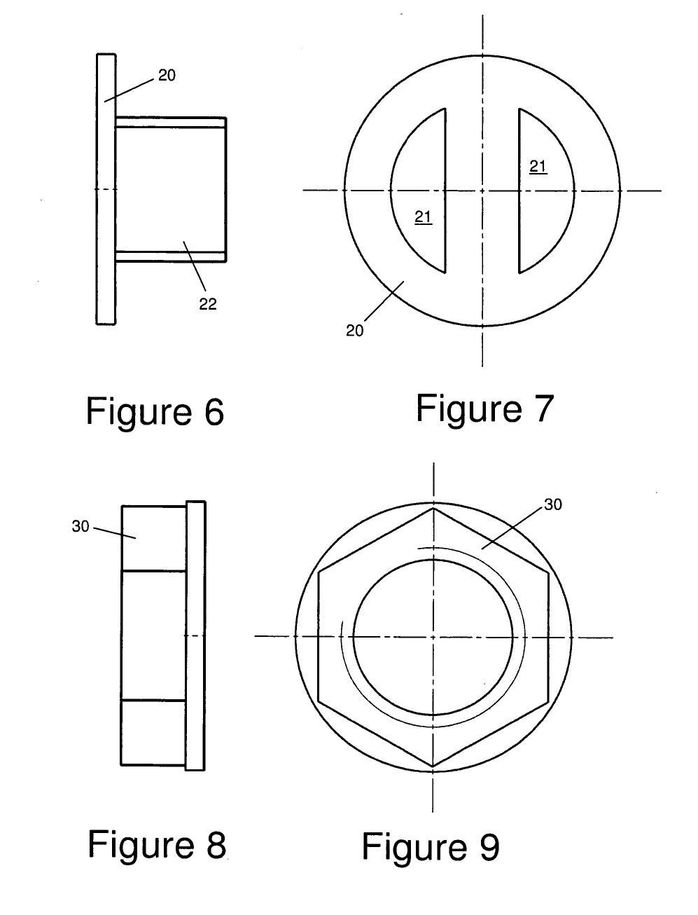

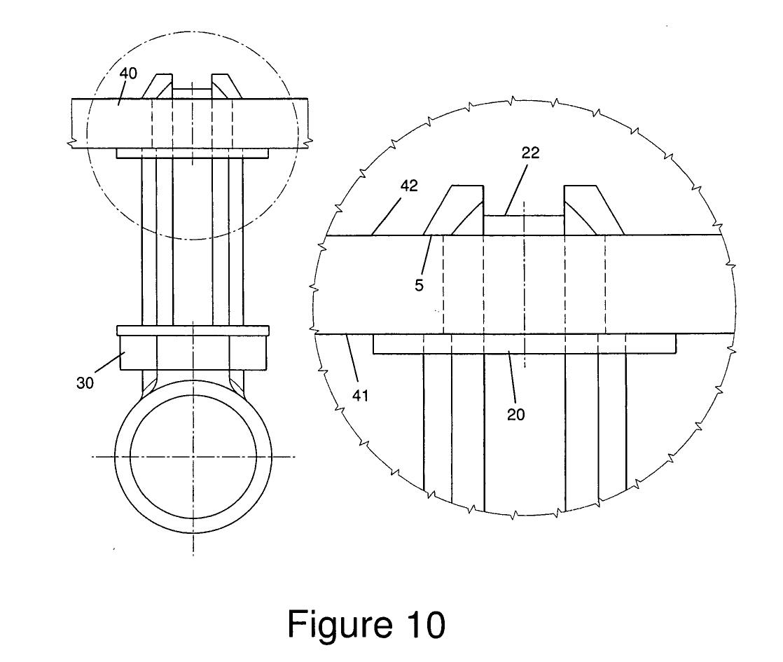

The shaft carries a washer shown in FIGS. 6 and 7. The washer comprises a clamping plate 20 with two holes 21 each receiving a respective one of the legs 4. A projection or tab 22 is carried by the clamping plate 20 and extends axially between the legs 4 towards their distal ends 6. The clamping plate 20 and projection 22 can be slid axially along the shaft from the retracted position shown in FIG. 1 to a locking position shown in FIG. 10.

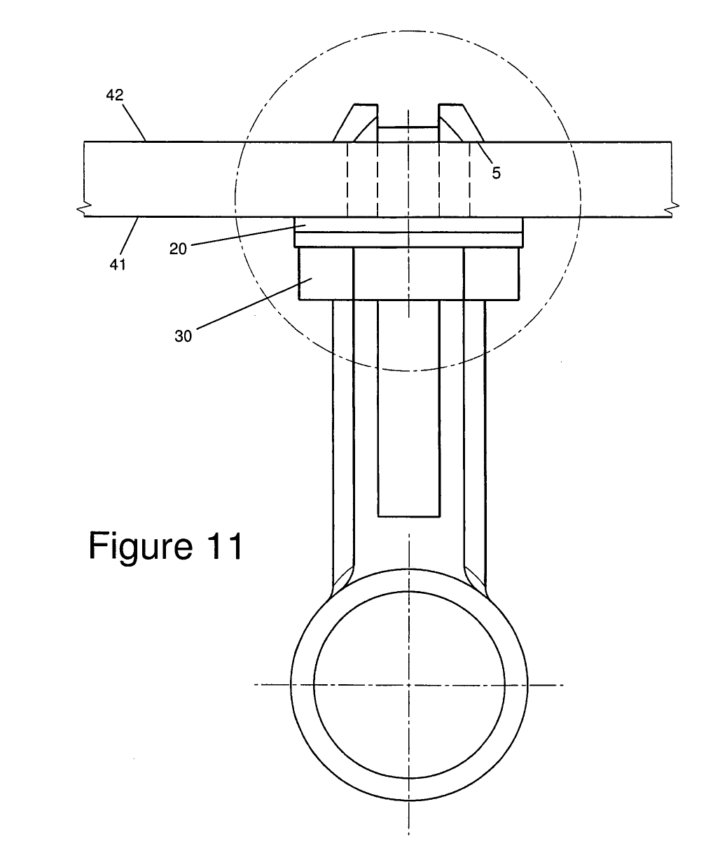

An internally threaded nut 30 shown in FIGS. 8 and 9 is carried by the shaft and can be spun along the thread 7 from the retracted position shown in FIGS. 1 and 10 to a locking position shown in FIG. 11.

The bracket is fixed to a panel 40 by the method shown in FIGS. 10 and 11. First the legs 4 are compressed together between finger and thumb so the catches 3 can pass through a hole from the front face 41 to the rear face 42 of the panel. When the catches have passed through the hole, the legs are released so that they spring back. As shown in FIG. 5, the legs 4 have curved outer faces 10 which lie on a cylinder which is concentric with the axis 11 of the shaft. Thus when the legs spring back, the faces 10 engage the cylindrical wall of the hole in the panel, or are at least concentric with the cylindrical wall of the hole.

Next the washer is slid axially along the shaft to a locking position where the rear face of the clamping plate 20 engages the front face 41 of the panel as shown in FIG. 10. Next the nut 30 is spun along the thread until it engages the front face of the clamping plate 20 as shown in FIG. 11, preventing the clamping plate and projection from withdrawing back along the shaft away from the catches 5.

Finally, the nut 30 is tightened so that the clamping plate 20 applies a compressive force to the front face of the panel and the faces 5 of the catches apply a compressive force to the rear face 42 of the panel. Compressing the panel 40 between the clamping plate 20 and catches 5 makes the bracket secure and unlikely to come loose due to vibration.

When the projection 22 is in its locking position between the catches as shown in FIGS. 10 and 11, it prevents them from collapsing radially inwardly to release the catches 5 from the rear face 42 of the panel. In its locking position shown in FIG. 10, the projection 22 passes through the hole and beyond the rear face 42 of the panel. However if the panel 40 is thicker then the projection 22 may lie flush with the rear face 42.

The bracket can be removed by reversing the process described above.

Once the bracket is fixed in place as in FIG. 11, the head 2 can then be used to hold a cylindrical object such as an aircraft fuel sensor, cable bundle, etc. Although a ring-shaped head 2 is shown in this example, the head may have any required shape. Furthermore, the head 2 may be omitted entirely and the single-sided fitting used as a blind rivet for fastening together a pair of panels.

Optionally an anti-rotation feature (not shown) may be provided between the nut and the washer that prevents the nut from spinning backwards due to vibration.

Where the bracket is fitted within a fuel tank, then preferably the bracket is sealed to prevent fuel from passing through the hole in the panel. This may be achieved in a number of ways. For example a liquid sealing material may be applied to the unthreaded portion 9 of the shaft and the tab 22 before the bracket is fitted to the panel. After the bracket has been fitted, the liquid sealing material cures to provide a fuel-tight seal with the hole in the panel. The fact that the tab 22 substantially fills the gap between the two legs 4 makes it relatively easy to form a seal in this manner.

Although the invention has been described above with reference to one or more preferred embodiments, it will be appreciated that various changes or modifications may be made without departing from the scope of the invention as defined in the appended claims.

1. A single-sided fitting comprising a shaft with two or more axially extending legs, each leg having a catch which extends radially outwardly from the leg; a clamping plate with two or more holes each receiving a respective one of the legs; a projection which is carried by the clamping plate and extends axially between the legs towards the catches, the clamping plate and projection being axially movable along the shaft to a locking position where the projection is positioned between the catches thus preventing the catches from moving radially inwardly; and means for preventing the clamping plate and projection from withdrawing back along the shaft away from the catches after they have been moved to the locking position.

2. The fitting of claim 1 wherein the means for preventing the clamping plate and projection from moving back along the shaft comprises an internally threaded nut which is carried by the shaft, the clamping plate being positioned between the nut and the catches, wherein the nut can be spun along the shaft to engage the clamping plate in its locking position.

3. The fitting of claim 2 wherein the nut is carried by a thread on the shaft which extends to a point which is set back from the catches by an unthreaded gap.

4. The fitting of claim 1 wherein the legs are joined together at a head of the shaft remote from the catches.

5. The fitting of claim 1 wherein the projection substantially fills a gap between the legs when it is in its locking position.

6. The fitting of claim 1 wherein the fitting is a bracket with a mounting part from which the shaft extends axially.

7. A joint comprising a structure with a hole passing from a front face of the structure to a rear face of the structure; and a single-sided fitting according to claim 1 arranged with the shaft passing through the hole, the clamping plate in its locking position applying a compressive force to the front face of the structure, the projection positioned between the catches thus preventing the catches from moving radially inwardly, and the catches applying a compressive force to the rear face of the structure.

8. The joint of claim 7 wherein the projection passes through the hole and beyond the rear face of the structure.

9. An aircraft comprising a joint according to claim 7.

10. A method of attaching a single-sided fitting to a structure, the single-sided fitting comprising a shaft with two or more axially extending legs, each leg having a catch which extends radially outwardly from the leg; a clamping plate with two or more holes each receiving a respective one of the legs, and a projection which is carried by the clamping plate and extends axially between the legs towards the catches, the method comprising:
passing the shaft and the catches through a hole from a front face of the structure to a rear face of the structure;
moving the catches radially outwardly so they cannot be withdrawn back through the hole;
moving the clamping plate and projection axially along the shaft to a locking position in which the clamping plate engages the front face of the structure and the projection is positioned between the catches, thus preventing the catches from moving radially inwardly;
applying a compressive force to the front face of the structure with the clamping plate;
applying a compressive force to the rear face of the structure with the catches; and
preventing the clamping plate and projection from withdrawing back along the shaft away from the catches after they have been moved to the locking position.

11. The method of claim 10 wherein the projection passes through the hole and beyond the rear face of the structure.

12. A method of disassembling the joint of claim 7, the method comprising: withdrawing the clamping plate and projection back along the shaft away from the catches; moving the catches radially inwardly; and withdrawing the shaft and the catches from the hole.

13. A single-sided fitting comprising a shaft with two or more axially extending legs, each leg having a catch which extends radially outwardly from the leg; an internally threaded nut which is carried by the shaft; a washer with two or more holes each receiving a respective one of the legs, the washer being positioned between the nut and the catches; a projection which is carried by the washer and extends axially between the legs towards the catches, the washer and projection being axially slidable along the shaft to a locking position where the projection is positioned between the catches thus preventing the catches from moving radially inwardly, wherein the nut can be spun along the shaft to retain the washer in its locking position.

14. The fitting of claim 13 wherein the nut is carried by a thread on the shaft which extends to a point which is set back from the catches by an unthreaded gap.

15. A joint comprising a structure with a hole passing from a front face of the structure to a rear face of the structure; and a single-sided fitting according to claim 13 arranged with the shaft passing through the hole, the clamping plate in its locking position applying a compressive force to the front face of the structure, the projection positioned between the catches thus preventing the catches from moving radially inwardly, the catches applying a compressive force to the rear face of the structure, and the nut retaining the washer in its locking position.
